(19) United States
(12) Patent Application Publication
(10) Pub. No.: US 2026/0122398 A1
(43) Pub. Date: Apr. 30, 2026

(54) HEARING DEVICE FOR A REPLACEABLE BATTERY

(71) Applicant: GN Hearing A/S, Ballerup (DK)

(72) Inventor: Emil Holm KNUDSEN, Ballerup (DK)

(73) Assignee: GN Hearing A/S, Ballerup (DK)

(21) Appl. No.: 19/352,925

(22) Filed: Oct. 8, 2025

(30) Foreign Application Priority Data
Oct. 31, 2024 (EP) 24210039

(51) Int. Cl. H04R 1/10

(52) U.S. Cl. CPC H04R 1/1058; H04R 2225/021; H04R 2225/025; H04R 2225/31

(57) ABSTRACT

A hearing device comprises a housing having a first section comprising first electronic component(s); a second section comprising second electronic component(s); a third section connecting the first and second sections; and a fourth section comprising a replaceable battery. The first and second sections are configured to move relatively to each other between a first position and a second position of the first section relative to the second section. When the first section is in the first position relative to the second section, the fourth section is in an open position, and the fourth section is open to an outside environment of the housing to allow replacement of the replaceable battery. When the first section is in the second position relative to the second section, the fourth section is in a closed position, and the fourth section is sealed from the outside environment of the housing.

### RELATED APPLICATION DATA

This application claims priority to, and the benefit of European Ser. No. 24/210,039 filed on Oct. 31, 2024. The entire disclosure of the above application is expressly incorporated by reference herein.

### FIELD

The present disclosure relates to a hearing device for a replaceable battery. More specifically, the disclosure relates to a hearing device configured to be worn in or at the ear of a user, the hearing device comprises a housing comprising a first section comprising one or more first electronic components and a second section comprising one or more second electronic components.

### BACKGROUND

The new EU Regulation 2027/1542 called the “Batteries Regulation”, relates to batteries in consumer electronics, and states that the batteries in consumer electronics must be replaceable by the user to ensure that batteries are collected, reused and recycled in Europe, for providing the green transition, support sustainable mobility and contribute to climate neutrality.

Thus, there is a need for an improved hearing device allowing the battery to be replaced.

### SUMMARY

Disclosed is a hearing device configured to be worn in or at the ear of a user. The hearing device comprises a housing. The housing comprises a first section comprising one or more first electronic components; a second section comprising one or more second electronic components; a third section connecting the first section and the second section; and a fourth section comprising a replaceable battery for supplying power. The first section and the second section are configured to move relative to each other between a first position and a second position of the first section relative to the second section. The fourth section is configured to be in an open position or in a closed position. When the first section is in the first position relative to the second section, the fourth section is in the open position, wherein the fourth section is open to an outside environment of the housing, thereby the replaceable battery is accessible for replacement. When the first section is in the second position relative to the second section, the fourth section is in the closed position, wherein the fourth section is sealed from the outside environment of the housing.

The hearing device may be an in-the-ear (ITE) hearing device, a behind-the-ear (BTE) hearing device, a receiver-in-the ear (RIE) hearing device, a microphone-and-receiver-in-the-ear (MaRIE) hearing device and/or an earbud hearing device.

Thus the hearing device is configured to be worn in the ear of a user or worn at the ear of a user, such as behind the ear.

The hearing device comprises a housing, and the housing may be a shell, an ITE shell, a BTE shell and/or an earbud shell.

The housing comprises a first section comprising one or more first electronic components. The first section may comprise a first printed circuit board. The one or more first electronic components may be input transducers, such as microphones, and/or push buttons etc. The first section may be a top part of the hearing device housing. If the hearing device is an ITE device or an earbud, the first section may be arranged in the concha of the ear, and thus the first section may point towards the surroundings in front and around the user, when the hearing device is arranged in the user's ear. Thus, there may be one or more input transducers arranged in this part, and the input transducer(s) may capture sound in the surroundings of the user. If the hearing device is a BTE or similar hearing device, the first section may be arranged behind the ear of the user, and thus the first section may point towards the surroundings behind and around the user, when the hearing device is arranged in the user's ear. Thus, there may be one or more input transducers arranged in this part, and the input transducer(s) may capture sound in the surroundings of the user.

When the hearing device is e.g. an ITE hearing device, the first section may be facing away from the ear canal, i.e. lateral direction, and the first section may comprise at least one input transducer. The second section may be closer to the tympanic membrane, i.e. ear drum, and the second section may comprise an output transducer, i.e. medial direction.

When the hearing device is e.g. a BTE hearing device, the first section may be facing away from the ear/head, and the first section may comprise at least one input transducer. The second section may be towards the skin of the ear/head, and the second section may comprise an output transducer, which is connected via a tube to an earpiece in the ear of the user.

The housing comprises a second section comprising one or more second electronic components. The second section may comprise a second printed circuit board. The one or more second electronic components may be output transducers, such as receivers, speaker, and/or sensors etc.

The housing comprises a third section connecting the first section and the second section. The third section may comprise a mechanical, e.g. physical connection, of the first section and the second section. The third section may comprise an electrical connection, e.g. an electrically wired connection, of the first section and the second section. The third section may comprise a third printed circuit board (PCB). The third PCB may be a flexible PCB. The third section being a PCB may comprise an electrical connection, such as implemented as wires in the PCB. The PCB may also be a mechanical connection. The third section may thus connect the first section and the second section both as an electrical connection and as a mechanical, or physical, connection. The third section may be arranged in between the first section and the second section, or the third section may extend from the first section toward the second section or vice versa. The first section and the second section may extend along a first direction. The third section may extends in a second direction from the first section to the second section. The second direction may be different from the first direction.

The housing comprises a fourth section comprising a replaceable battery for supplying power. Thus, the fourth section may be a battery compartment. The replaceable battery may be a rechargeable battery. The battery may be a lithium-ion battery, or other kind of rechargeable battery. The battery may be configured for supplying power to the one or more first electronic components and/or to the one or more second electronic components.

The first, second, third and fourth sections may be separate from each other.

The first section and the second section are configured to move relatively to each other between a first position and a second position of the first section relative to the second section. Thus, the first section may be in a first position relative to the second section, and/or the first section may be in a second position relative to the second section.

The fourth section is configured to be in an open position or in a closed position. When the first section is in the first position relative to the second section, the fourth section is in the open position, wherein the fourth section is open to an outside environment of the housing, thereby the replaceable battery is accessible for replacement. Thus, when the first section is in the first position relative to the second section, this configuration may provide an opening of the housing of the hearing device such that the fourth section becomes open and the battery is accessible for replacement. When the battery is accessible for replacement, the battery may be configured to be detached from the fourth section of the housing, and the battery may be configured to be inserted in the fourth section of the housing.

When the first section is in the second position relative to the second section, the fourth section is in the closed position, wherein the fourth section is sealed from the outside environment of the housing. Thus, when the first section is in the second position relative to the second section, this configuration may provide an closing of the housing of the hearing device such that the fourth section becomes closed and the battery is not accessible for replacement.

It is an advantage that the battery may be is accessible for replacement by the user, and not neccesarily by a professional hearing care professional. For example when the battery is not working properly anymore, the battery may be replaced by the user. Even though the battery may be a rechargeable battery, the battery may still need to be replaced some times. Or when the hearing device is to be disposed, then it is an advantage that the hearing device can be separated into different parts for recycling, e.g. such that the battery can be recycled.

The new EU Regulation 2027/1542 called the “Batteries Regulation”, relates to batteries in consumer electronics, and states that the batteries in consumer electronics must be replaceable by the user to ensure that batteries are collected, reused and recycled in Europe. The new Batteries Regulation will ensure that, in the future, batteries have a low carbon footprint, use minimal harmful substances, need less raw materials from non-EU countries, and are collected, reused and recycled to a high degree in Europe. This will support the shift to a circular economy, increase security of supply for raw materials and energy, and enhance the EU's strategic autonomy. In line with the circularity ambitions of the European Green Deal, the Batteries Regulation is the first piece of European legislation taking a full life-cycle approach in which sourcing, manufacturing, use and recycling are addressed and enshrined in a single law. Batteries are a key technology to drive the green transition, support sustainable mobility and contribute to climate neutrality by 2050.

It is an advantage that the hearing device provides an easy battery change while still providing reliability and protection of the electronic components in the hearing device.

Prior art hearing device, such as headsets, earbuds or hearing aids, often use rechargeable batteries, which means that the user recharges the hearing device battery, while the battery stays in the hearing device, thus the battery is not removed or inserted in the hearing device by the user, but typically the battery stays in the hearing device for the entire lifetime of the hearing device. Therefore, the rechargeable battery is typically not replaceable, but instead the rechargeable battery is firmly mounted into the hearing device.

In prior art, traditional mechanical architectures for e.g. in-ear devices, may be build up around a frame module that holds the electronics and a rechargeable battery, and to close off the frame element outer shells are attached. In prior art, the shells are often glued or welded together to make a watertight compartment around the critical electrical components.

Thus, for the present hearing device which is configured to allow for battery exchange by the user, it is an advantage that the electronics is protected in the hearing device and that the battery is still easily accessible by the user.

Thus, it is an advantage of the present hearing device that the housing of the hearing device may be like a frame element which is split in at least two parts, and then each part is provided to create a sealed compartment around e.g. a top assembly, i.e. the first section, and a botton assembly, i.e. the second section, where the two assemblies may be connected by a PCB flex tail, i.e. the third section.

It is an advantage that this structure makes it possible to keep the electronics sealed for a reliability purpose, and also allow for easy battery exchange because the at least two parts of the housing can be separated.

It is a further advantage that the electronic components are protected such that the user cannot access the electronics. If the user could access the electronics, the user could accidentally destroy the hearig device or get shocks.

In some embodiments, the one or more first electronic components are sealed, and wherein the one or more second electronic components are sealed. It is an advantage to seal the electronic components in order to avoid corrosion. It is also an advantage that the electronic components are sealed because hereby they are protected such that the user cannot directly access the electronics. If the user could access the electronics, the user could accidentally destroy the hearing device, get in contact with harmful materials, or get shocks.

In some embodiments, the one or more first electronic components and/or the one or more second electronic components are sealed by coating and/or overmoulding.

In some embodiments, the first, second, third and fourth sections are separate from each other. Thus, the sections are separate from other, such as sealed off from each other, such as split in different parts, such as closed off from other. Each section may be sealed separately, such as each section may be coated separately, or each section may be overmoulded separately. Even though the sections are separate from each other, they may still be connected via a PCB, such as the first section and the second section may be connected via the third section, which may be a flex PBC.

In some embodiments, the third section comprises an attachment component, wherein the first section and the second section are connected to each other via the third section at the attachment component, and wherein the first section and the second section are configured to be movable relative to each other around the attachment component. The attachment component may be a hinge point, where the first section and the second section are hinged to each other.

In some embodiments, the first section and the second section are configured to be movable relative to each other around the attachment component as a rotational movement or as a translational movement. Thus the movement may be a rotational movement around the attachment component, or the movement may be a translational movement around the attachment component. Alternatively, the first section and the second section may not be connected via an attachment component, but they be configured for moving unrelated to each other such as by being completely separated when opening the housing. The first section and the second section may still be connected by the third section, e.g. a flex PCB which will still be connecting the parts.

In some embodiments, the first section comprises a first printed circuit board (PCB), and wherein the second section comprises a second printed circuit board (PCB), and wherein the third section comprises a third printed circuit board (PCB) electrically connecting the first section and the second section.

In some embodiments, the third printed circuit board (PCB) is a flex PCB which is configured to be bendable, thereby allowing the fourth section to be in the open position, whereby the replaceable battery is accessible for replacement. It is an advantage that the third section may be third PBC which may be a flex PCB, since hereby the first section and the second section may move relative to each other for providing the open position of the fourth section allowing the battery to be replaced.

In some embodiments, the attachment component comprises the third PCB.

In some embodiments, the battery is configured for supplying power to the electronic components by means of one or more battery contacts, and wherein the one or more battery contacts are arranged in the first section and/or in the second section. Thus, the one or more first electronic components in the first section may be supplied with battery power, and the one or more second electronic components in the second section may be supplied with battery power. The third section may not have any electronic components which must be supplied with power from the battery. Battery contacts may provide the battery supply, anf the battery contacts may be arranged in the first section and/or in the second section. The battery contacts may be terminals, pogo pins, springs, transfer points, electrical conductive materials etc.

In some embodiments, the replaceable battery is a rechargeable battery.

In some embodiments, the housing is configured to be securily closed at the fourth section by means of a connector, snap-fit, magnetic elements, screw, pin, glue, adhesive, and/or a spring. Thus, when the fourth section is in the closed position, it is an advantage that the closed position is securely closed ensuring that the housing is firmly closed and that the hearing device works properly, therefore there may be an extra closing means in form of e.g. a screw or pin. Thus, the above are mechanical connections.

In some embodiments, the hearing device comprises means for electrical connection, e.g. for data transfer. The electrical connection may be between the first section and the second section. The electrical connection may be by means of an electrical connector and/or by magnetic elements.

In some embodiments, the first section is enclosed by a first physical shielding, and wherein the second section is enclosed by a second physical shielding.

In some embodiments, the first physical shielding and/or the second physical shielding is/are a partition and/or an overmoulded material.

In some embodiments, the hearing device is an in-the-ear (ITE) hearing device, a behind-the-ear (BTE) hearing device, a receiver-in-the ear (RIE) hearing device, a microphone-and-receiver-in-the-ear (MaRIE) hearing device and/or an earbud hearing device, and wherein the housing is an ITE shell, BTE shell and/or an earbud shell.

In some embodiments, the one or more first electronic components is an input transducer. Thus, they may be an input transducer, e.g. a microphone in the first section. The first section may be a top part of the hearing device housing. If the hearing device is an ITE device or an earbud, the first section may be arranged in the concha of the ear, and thus the first section may point towards the surroundings in front and around the user, when the hearing device is arranged in the user's ear. Thus, there may be one or more input transducers arranged in this part, and the input transducer(s) may capture sound in the surroundings of the user.

If the hearing device is a BTE or similar hearing device, the first section may be arranged behind the ear of the user, and thus the first section may point towards the surroundings behind and around the user, when the hearing device is arranged in the user's ear. Thus, there may be one or more input transducers arranged in this part, and the input transducer(s) may capture sound in the surroundings of the user.

In some embodiments, the one or more second electronic components is an output transducer. Thus, there may be an output transducer, e.g. a speaker, receiver in the second section. The second section may be a bottom part of the hearing device housing. If the hearing device is an ITE device or an earbud, the second section may be arranged in the ear canal of the ear, and thus the second section may point towards the ear canal and the tymphanic membrane of the user's ear, when the hearing device is arranged in the user's ear. Thus, there may be one or more output transducers arranged in this part, and the output transducer(s) may transmit sound to the ear canal of the user.

If the hearing device is a BTE or similar hearing device, the second section may be towards the skin of the ear/head, and the second section may comprise an output transducer, which is connected via a tube to an earpiece in the ear of the user.

In an embodiment, a hearing device is configured to be worn by a user. The hearing device may be arranged at the user's ear, on the user's ear, over the user's ear, in the user's ear, in the user's ear canal, behind the user's ear and/or in the user's concha, i.e., the hearing device is configured to be worn in, on, over and/or at the user's ear. The user may wear two hearing devices, one hearing device at each ear. The two hearing devices may be connected, such as wirelessly connected and/or connected by wires, such as a binaural hearing aid system.

The hearing device may be a hearable such as a headset, headphone, earphone, earbud, hearing aid, a personal sound amplification product (PSAP), an over-the-counter (OTC) hearing device, a hearing protection device, a one-size-fits-all hearing device, a custom hearing device or another head-wearable hearing device. Hearing devices can include both prescription devices and non-prescription devices.

The hearing device may be embodied in various housing styles or form factors. Some of these form factors are Behind-the-Ear (BTE) hearing device, Receiver-in-Canal (RIC) hearing device, Receiver-in-Ear (RIE) hearing device or Microphone-and-Receiver-in-Ear (MaRIE) hearing device. These devices may comprise a BTE unit configured to be worn behind the ear of the user and an in the ear (ITE) unit configured to be inserted partly or fully into the user's ear canal. Generally, the BTE unit may comprise at least one input transducer, a power source and a processing unit. The term BTE hearing device refers to a hearing device where the receiver, i.e. the output transducer, is comprised in the BTE unit and sound is guided to the ITE unit via a sound tube connecting the BTE and ITE units, whereas the terms RIE, RIC and MaRIE hearing devices refer to hearing devices where the receiver may be comprise in the ITE unit, which is coupled to the BTE unit via a connector cable or wire configured for transferring electric signals between the BTE and ITE units.

Some of these form factors are In-the-Ear (ITE) hearing device, Completely-in-Canal (CIC) hearing device or Invisible-in-Canal (IIC) hearing device. These hearing devices may comprise an ITE unit, wherein the ITE unit may comprise at least one input transducer, a power source, a processing unit and an output transducer. These form factors may be custom devices, meaning that the ITE unit may comprise a housing having a shell made from a hard material, such as a hard polymer or metal, or a soft material such as a rubber-like polymer, molded to have an outer shape conforming to the shape of the specific user's ear canal.

Some of these form factors are earbuds, on the ear headphones or over the ear headphones. The person skilled in the art is well aware of different kinds of hearing devices and of different options for arranging the hearing device in, on, over and/or at the ear of the hearing device wearer. The hearing device (or pair of hearing devices) may be custom fitted, standard fitted, open fitted and/or occlusive fitted.

In an embodiment, the hearing device may comprise one or more input transducers. The one or more input transducers may comprise one or more microphones. The one or more input transducers may comprise one or more vibration sensors configured for detecting bone vibration. The one or more input transducer(s) may be configured for converting an acoustic signal into a first electric input signal. The first electric input signal may be an analogue signal. The first electric input signal may be a digital signal. The one or more input transducer(s) may be coupled to one or more analogue-to-digital converter(s) configured for converting the analogue first input signal into a digital first input signal.

In an embodiment, the hearing device may comprise one or more antenna(s) configured for wireless communication. The one or more antenna(s) may comprise an electric antenna. The electric antenna may be configured for wireless communication at a first frequency. The first frequency may be above 800 MHz, preferably a wavelength between 900 MHz and 6 GHz. The first frequency may be 902 MHz to 928 MHz. The first frequency may be 2.4 to 2.5 GHz. The first frequency may be 5.725 GHz to 5.875 GHz. The one or more antenna(s) may comprise a magnetic antenna. The magnetic antenna may comprise a magnetic core. The magnetic antenna may comprise a coil. The coil may be coiled around the magnetic core. The magnetic antenna may be configured for wireless communication at a second frequency. The second frequency may be below 100 MHz. The second frequency may be between 9 MHz and 15 MHz.

In an embodiment, the hearing device may comprise one or more wireless communication unit(s). The one or more wireless communication unit(s) may comprise one or more wireless receiver(s), one or more wireless transmitter(s), one or more transmitter-receiver pair(s) and/or one or more transceiver(s). At least one of the one or more wireless communication unit(s) may be coupled to the one or more antenna(s). The wireless communication unit may be configured for converting a wireless signal received by at least one of the one or more antenna(s) into a second electric input signal. The hearing device may be configured for wired/wireless audio communication, e.g. enabling the user to listen to media, such as music or radio and/or enabling the user to perform phone calls.

In an embodiment, the wireless signal may originate from one or more external source(s) and/or external devices, such as spouse microphone device(s), wireless audio transmitter(s), smart computer(s) and/or distributed microphone array(s) associated with a wireless transmitter. The wireless input signal(s) may origin from another hearing device, e.g., as part of a binaural hearing system and/or from one or more accessory device(s), such as a smartphone and/or a smart watch.

In an embodiment, the hearing device may include a processing unit. The processing unit may be configured for processing the first and/or second electric input signal(s). The processing may comprise compensating for a hearing loss of the user, i.e., apply frequency dependent gain to input signals in accordance with the user's frequency dependent hearing impairment. The processing may comprise performing feedback cancelation, beamforming, tinnitus reduction/masking, noise reduction, noise cancellation, speech recognition, bass adjustment, treble adjustment and/or processing of user input. The processing unit may be a processor, an integrated circuit, an application, functional module, etc. The processing unit may be implemented in a signal-processing chip or a printed circuit board (PCB). The processing unit may be configured to provide a first electric output signal based on the processing of the first and/or second electric input signal(s). The processing unit may be configured to provide a second electric output signal. The second electric output signal may be based on the processing of the first and/or second electric input signal(s).

In an embodiment, the hearing device may comprise an output transducer. The output transducer may be coupled to the processing unit. The output transducer may be a receiver. It is noted that in this context, a receiver may be a loudspeaker, whereas a wireless receiver may be a device configured for processing a wireless signal. The receiver may be configured for converting the first electric output signal into an acoustic output signal. The output transducer may be coupled to the processing unit via the magnetic antenna. The output transducer may be comprised in an ITE unit or in an earpiece, e.g. Receiver-in-Ear (RIE) unit or Microphone-and-Receiver-in-Ear (MaRIE) unit, of the hearing device. One or more of the input transducer(s) may be comprised in an ITE unit or in an earpiece.

In an embodiment, the wireless communication unit may be configured for converting the second electric output signal into a wireless output signal. The wireless output signal may comprise synchronization data. The wireless communication unit may be configured for transmitting the wireless output signal via at least one of the one or more antennas.

In an embodiment, the hearing device may comprise a digital-to-analogue converter configured to convert the first electric output signal, the second electric output signal and/or the wireless output signal into an analogue signal.

In an embodiment, the hearing device may comprise a vent. A vent is a physical passageway such as a canal or tube primarily placed to offer pressure equalization across a housing placed in the ear such as an ITE hearing device, an ITE unit of a BTE hearing device, a CIC hearing device, a RIE hearing device, a RIC hearing device, a MaRIE hearing device or a dome tip/earmold. The vent may be a pressure vent with a small cross section area, which is preferably acoustically sealed. The vent may be an acoustic vent configured for occlusion cancellation. The vent may be an active vent enabling opening or closing of the vent during use of the hearing device. The active vent may comprise a valve.

In an embodiment, the hearing device may comprise a power source. The power source may comprise a battery providing a first voltage. The battery may be a rechargeable battery. The battery may be a replaceable battery. The power source may comprise a power management unit. The power management unit may be configured to convert the first voltage into a second voltage. The power source may comprise a charging coil. The charging coil may be provided by the magnetic antenna.

In an embodiment, the hearing device may comprise a memory, including volatile and non-volatile forms of memory.

The present disclosure relates to different aspects including the hearing device described above and in the following, and corresponding device parts, each yielding one or more of the benefits and advantages described in connection with the first mentioned aspect, and each having one or more embodiments corresponding to the embodiments described in connection with the first mentioned aspect and/or disclosed in the appended claims.

### BRIEF DESCRIPTION OF THE DRAWINGS

The above and other features and advantages will become readily apparent to those skilled in the art by the following detailed description of exemplary embodiments thereof with reference to the attached drawings, in which:

FIGS. 1a and 1b schematically illustrates an exemplary earbud type hearing device.

FIG. 2 schematically illustrates an exemplary ITE hearing device.

FIGS. 3a and 3b schematically illustrates an exemplary earbud type hearing device with physical shielding(s) around sections in the hearing device.

FIGS. 4a, 4b, 5a, 5b, 6a and 6b schematically illustrates an exemplary ITE hearing device with an attachment component for rotational movement or translational movement of a first section and second section of the hearing device.

FIGS. 7a, 7b, 7c, 7d, 7e and 7f schematically illustrates an examplary ITE hearing device with means for electrical connection in the hearing device.

FIGS. 8a, 8b, 8c, 8d and 8e schematically illustrates an exemplary BTE hearing device housings for BTE hearing devices, RIE hearing devices and MaRIE hearing devices.

### DETAILED DESCRIPTION

Various embodiments are described hereinafter with reference to the figures. Like reference numerals refer to like elements throughout. Like elements will, thus, not be described in detail with respect to the description of each figure. It should also be noted that the figures are only intended to facilitate the description of the embodiments. They are not intended as an exhaustive description of the claimed invention or as a limitation on the scope of the claimed invention. In addition, an illustrated embodiment needs not have all the aspects or advantages shown. An aspect or an advantage described in conjunction with a particular embodiment is not necessarily limited to that embodiment and can be practiced in any other embodiments even if not so illustrated, or if not so explicitly described.

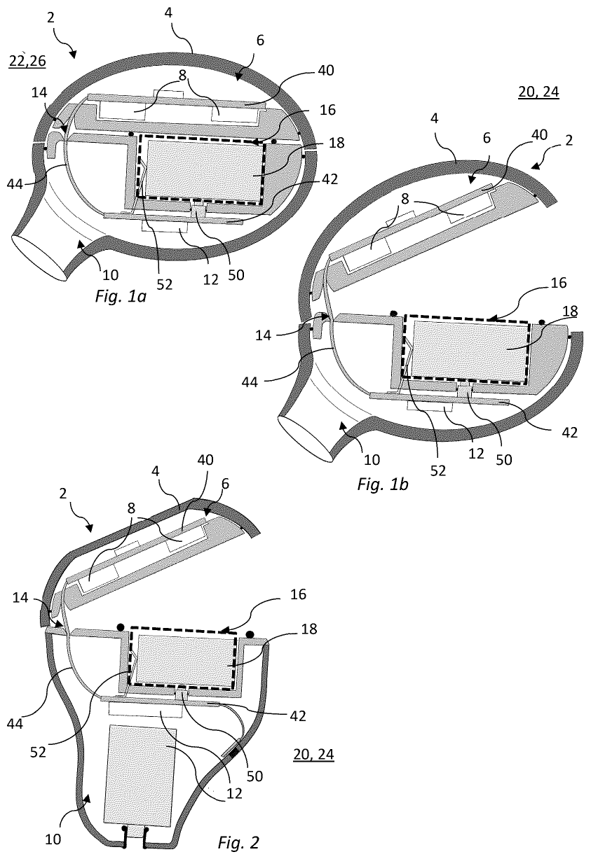

FIGS. 1a and 1b schematically illustrates an exemplary standard fitting ITEhearing device. FIGS. 1a and 1b schematically illustrates an examplary hearing device 2 configured to be worn in or at the ear of a user. The hearing device 2 comprises a housing 4. The housing 4 comprises a first section 6 comprising one or more first electronic components 8. The housing 4 comprises a second section 10 comprising one or more second electronic components 12. The housing 4 comprises a third section 14 connecting the first section 6 and the second section 10. The housing 4 comprises a fourth section 16 comprising a replaceable battery 18 for supplying power. The first section 6 and the second section 10 are configured to move relative to each other between a first position 20 and a second position 22 of the first section 6 relative to the second section 10.

FIG. 1a shows the second position 22 of the first section 6 relative to the second section 10.

FIG. 1b shows the first position 20 of the first section 6 relative to the second section 10.

The fourth section 16 is configured to be in an open position 24 or in a closed position 26.

FIG. 1a shows the closed position 26 of the fourth section 16.

FIG. 1b shows the open position 24 of the fourth section 16.

When the first section 6 is in the first position 20 relative to the second section 10, the fourth section 16 is in the open position 24, wherein the fourth section 16 is open to an outside environment of the housing 4, whereby the replaceable battery 18 is accessible for replacement, as seen in FIG. 1b.

When the first section 6 is in the second position 22 relative to the second section 10, the fourth section 16 is in the closed position 26, wherein the fourth section 16 is sealed from the outside environment of the housing 4, as seen in FIG. 1a.

The first section 6 may comprise a first printed circuit board (PCB) 40, the second section 10 may comprise a second PCB 42, and the third section 14 may comprise a third PCB 44 mechanically and electrically connecting the first section 6 and the second section 10. The third PCB 44 may be a flex PCB which is configured to be bendable, thereby allowing the fourth section 16 to be in the open position 24, whereby the replaceable battery 18 is accessible for replacement.

The battery 18 is configured for supplying power to the electronic components 8, 12 by means of one or more battery contacts 50, 52. The one or more battery contacts 50, 52 may be are arranged in the first section 6, in the second section 10 and/or in the fourth section 16.

The hearing device 2 in FIGS. 1a and 1b is illustrated as an earbud type hearing device.

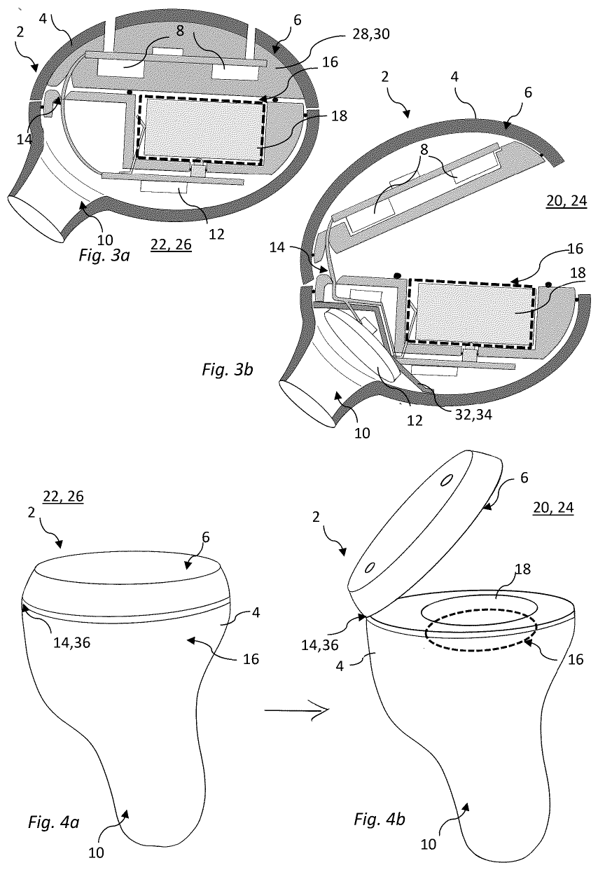

FIG. 2 schematically illustrates an exemplary standard fitting ITE hearing device. FIG. 2 schematically illustrates an examplary hearing device 2 configured to be worn in or at the ear of a user. The hearing device 2 comprises a housing 4. The housing 4 comprises a first section 6 comprising one or more first electronic components 8. The housing 4 comprises a second section 10 comprising one or more second electronic components 12. The housing 4 comprises a third section 14 connecting the first section 6 and the second section 10. The housing 4 comprises a fourth section 16 comprising a replaceable battery 18 for supplying power. The first section 6 and the second section 10 are configured to move relative to each other between a first position 20 and a second position 22 of the first section 6 relative to the second section 10.

FIG. 2 shows the first position 20 of the first section 6 relative to the second section 10.

The fourth section 16 is configured to be in an open position 24 or in a closed position 26.

FIG. 2 shows the open position 24 of the fourth section 16.

When the first section 6 is in the first position 20 relative to the second section 10, the fourth section 16 is in the open position 24, wherein the fourth section 16 is open to an outside environment of the housing 4, whereby the replaceable battery 18 is accessible for replacement, as seen in FIG. 2.

When the first section 6 is in the second position 22 relative to the second section 10, the fourth section 16 is in the closed position 26, wherein the fourth section 16 is sealed from the outside environment of the housing 4.

The first section 6 may comprise a first printed circuit board (PCB) 40, the second section 10 may comprise a second PCB 42, and the third section 14 may comprise a third PCB 44 mechanically and electrically connecting the first section 6 and the second section 10. The third PCB 44 may be a flex PCB which is configured to be bendable, thereby allowing the fourth section 16 to be in the open position 24, whereby the replaceable battery 18 is accessible for replacement.

The battery 18 is configured for supplying power to the electronic components 8, 12 by means of one or more battery contacts 50, 52. The one or more battery contacts 50, 52 may be are arranged in the first section 6, in the second section 10 and/or in the fourth section 16.

The hearing device 2 in FIG. 2 is illustrated as an ITE hearing device.

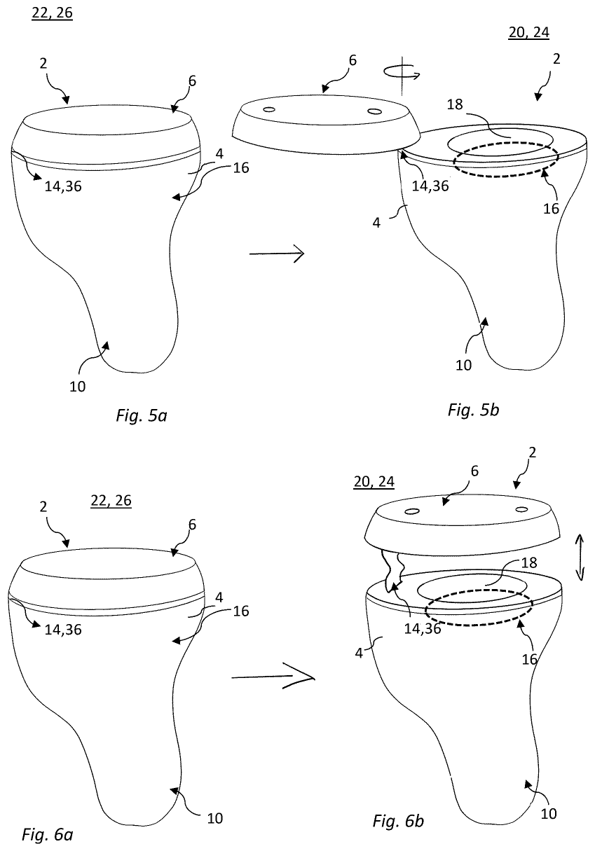

FIGS. 3a and 3b schematically illustrates an exemplary standard fitting ITE hearing device with physical shielding(s) around sections in the hearing device. FIGS. 3a and 3b schematically illustrates an examplary hearing device 2 as shown in FIGS. 1a and 1b. Thus, we refer to the features and reference signs as explained in connection with FIGS. 1a and 1b.

FIG. 3a furthermore shows that the first section 6 is enclosed by a first physical shielding 28, and the first physical shielding 28 is an overmoulded material 30. The overmoulded material 30 encloses the first electronic component(s) 8.

FIG. 3b furthermore shows that the second section 10 is enclosed by a second physical shielding 32, and the second physical shielding 32 is a partition 34.

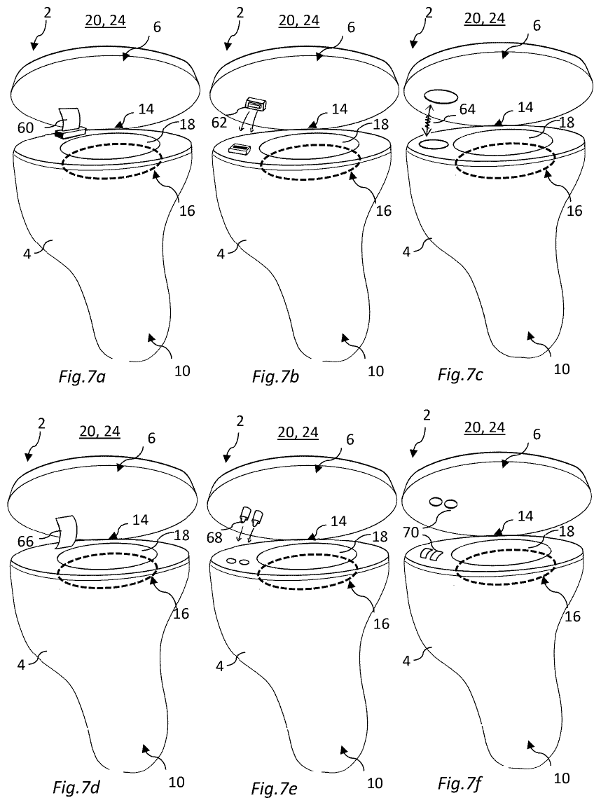

FIGS. 4a, 4b, 5a, 5b, 6a and 6b schematically illustrates an exemplary cusmotized ITE hearing device with an attachment component for rotational movement or translational movement of a first section and second section of the hearing device. FIGS. 4a, 4b, 5a, 5b, 6a and 6b schematically illustrates an examplary hearing device 2 configured to be worn in or at the ear of a user. The hearing device 2 comprises a housing 4. The housing 4 comprises a first section 6. The housing 4 comprises a second section 10. The housing 4 comprises a third section 14 connecting the first section 6 and the second section 10. The housing 4 comprises a fourth section 16 comprising a replaceable battery 18 for supplying power. The first section 6 and the second section 10 are configured to move relative to each other between a first position 20 and a second position 22 of the first section 6 relative to the second section 10.

FIGS. 4a, 5a and 6a show the second position 22 of the first section 6 relative to the second section 10.

FIGS. 4b, 5b and 6b show the first position 20 of the first section 6 relative to the second section 10.

The fourth section 16 is configured to be in an open position 24 or in a closed position 26.

FIGS. 4a, 5a and 6a show the closed position 26 of the fourth section 16.

FIGS. 4b, 5b and 6b show the open position 24 of the fourth section 16.

When the first section 6 is in the first position 20 relative to the second section 10, the fourth section 16 is in the open position 24, wherein the fourth section 16 is open to an outside environment of the housing 4, whereby the replaceable battery 18 is accessible for replacement, as seen in FIGS. 4b, 5b and 6b.

When the first section 6 is in the second position 22 relative to the second section 10, the fourth section 16 is in the closed position 26, wherein the fourth section 16 is sealed from the outside environment of the housing 4, as seen in FIGS. 4a, 5a and 6a.

The hearing device 2 in FIGS. 4a, 4b, 5a, 5b, 6a and 6b is illustrated as an customized ITE hearing device.

The third section 14 comprises an attachment component 36. The first section 6 and the second section 10 are connected to each other via the third section 14 at the attachment component 36. The first section 6 and the second section 10 are configured to be movable relative to each other around the attachment component 36.

The third section 14 and the attachment component 36 may be a flex PCB.

The first section 6 and the second section 10 are configured to be movable relative to each other around the attachment component 36 as a rotational movement as seen in FIGS. 4a and 4b, and 5a and 5b, respectively, or as a translational movement as seen in FIGS. 6a and 6b.

The attachment component 36 may be a hinge or ball point, which provides rotational movement. The attachment component 36 may be a flex PCB or connection tape, which provides translational movement.

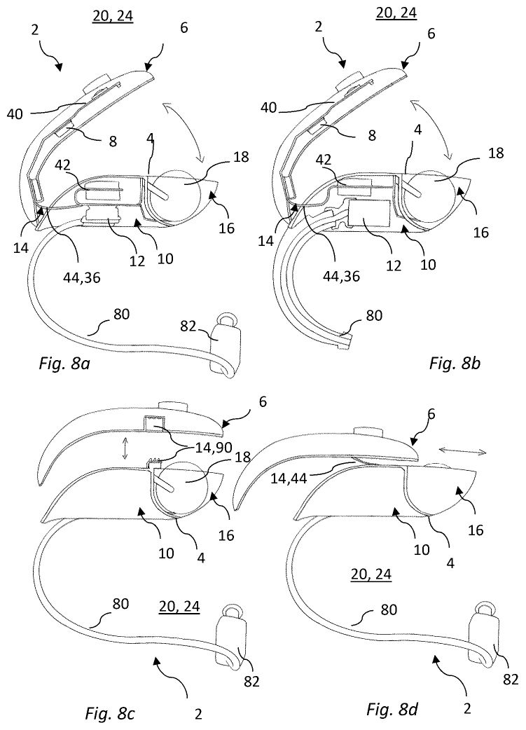

FIGS. 7a, 7b, 7c, 7d, 7e and 7f schematically illustrates an examplary ITE hearing device with means for electrical connection in the hearing device. FIGS. 7a, 7b, 7c, 7d, 7e and 7f schematically illustrates an examplary hearing device 2 configured to be worn in or at the ear of a user. The hearing device 2 comprises a housing 4. The housing 4 comprises a first section 6. The housing 4 comprises a second section 10. The housing 4 comprises a third section 14 connecting the first section 6 and the second section 10. The housing 4 comprises a fourth section 16 comprising a replaceable battery 18 for supplying power. The first section 6 and the second section 10 are configured to move relative to each other between a first position 20 and a second position of the first section 6 relative to the second section 10.

The FIGS. 7a, 7b, 7c, 7d, 7e and 7f show the first position 20 of the first section 6 relative to the second section 10.

The fourth section 16 is configured to be in an open position 24 or in a closed position.

The FIGS. 7a, 7b, 7c, 7d, 7e and 7f show the open position 24 of the fourth section 16.

When the first section 6 is in the first position 20 relative to the second section 10, the fourth section 16 is in the open position 24, wherein the fourth section 16 is open to an outside environment of the housing 4, whereby the replaceable battery 18 is accessible for replacement, as seen in the figs.

When the first section 6 is in the second position relative to the second section 10, the fourth section 16 is in the closed position, wherein the fourth section 16 is sealed from the outside environment of the housing 4.

The hearing device 2 may comprise means for electrical connection, e.g. for data transfer and power transmission. The electrical connection may be between the first section 6 and the second section 10. The electrical connection may be by means of an electrical connector 60 or 62 or 66 as shown in FIGS. 7a, 7b and 7d, and/or by magnetic elements 64, 70 or 68 as shown in FIGS. 7c, 7f and FIG. 7e.

The hearing device 2 in the FIGS. 7a, 7b, 7c, 7d, 7e and 7f is illustrated as an ITE hearing device.

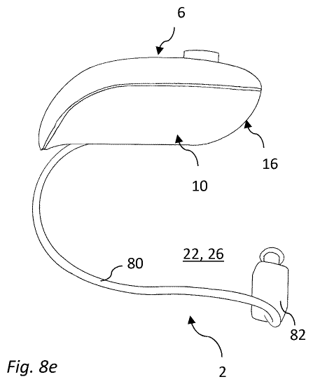

FIGS. 8a, 8b, 8c, 8d and 8e schematically illustrates exemplary BTE hearing device housings for BTE hearing devices, RIE hearing devices and MaRIE hearing devices. FIGS. 8a, 8b, 8c, 8d and 8e schematically illustrates an examplary hearing device 2 configured to be worn in or at the ear of a user. The hearing device 2 comprises a housing 4. The housing 4 comprises a first section 6 comprising one or more first electronic components 8. The housing 4 comprises a second section 10 comprising one or more second electronic components 12. The housing 4 comprises a third section 14 connecting the first section 6 and the second section 10. The housing 4 comprises a fourth section 16 comprising a replaceable battery 18 for supplying power. The first section 6 and the second section 10 are configured to move relative to each other between a first position 20 and a second position 22 of the first section 6 relative to the second section 10.

The FIGS. 8a-8d show the first position 20 of the first section 6 relative to the second section 10.

The fourth section 16 is configured to be in an open position 24 or in a closed position 26.

The FIGS. 8a, 8b, 8c, and 8d show the open position 24 of the fourth section 16.

When the first section 6 is in the first position 20 relative to the second section 10, the fourth section 16 is in the open position 24, wherein the fourth section 16 is open to an outside environment of the housing 4, whereby the replaceable battery 18 is accessible for replacement, as seen in the figs.

FIG. 8e shows that when the first section 6 is in the second position 22 relative to the second section 10, the fourth section 16 is in the closed position 26, wherein the fourth section 16 is sealed from the outside environment of the housing 4.

The first section 6 may comprise a first printed circuit board (PCB) 40, the second section 10 may comprise a second PCB 42, and the third section 14 may comprise a third PCB 44 (FIGS. 8a, 8b and 8d) electrically connecting the first section 6 and the second section 10. The third PCB 44 may be a flex PCB which is configured to be bendable, thereby allowing the fourth section 16 to be in the open position 24, whereby the replaceable battery 18 is accessible for replacement.

The third section 14 comprises an attachment component 36, as seen in FIGS. 8a and 8b. The first section 6 and the second section 10 are connected to each other via the third section 14 at the attachment component 36. The first section 6 and the second section 10 are configured to be movable relative to each other around the attachment component 36.

The third section 14 and the attachment component 36 may be a flex PCB.

The hearing device 2 may comprise means for electrical connection, e.g. for data transfer and power transmission. The electrical connection may be between the first section 6 and the second section 10. The electrical connection may be by means of an electrical connector and/or by magnetic elements.

In FIG. 8c, the third section 14 may comprise an electrical connector 90 electrically connecting the first section 6 and the second section 10, thereby allowing the fourth section 16 to be in the open position 24, whereby the replaceable battery 18 is accessible for replacement.

The first section 6 and the second section 10 are configured to be movable relative to each other around the attachment component 36 as a rotational movement as seen in FIGS. 8a and 8b, or at the electrical connector 90 or third flex PCB 44 as a translational movement as seen in FIGS. 8c and 8d.

The hearing device 2 in the FIGS. 8a, 8b, 8c, 8d and 8e is illustrated as an BTE hearing device housing for BTE hearing devices, RIE hearing devices and MaRIE hearing devices. A BTE hearing device has a receiver in the BTE housing. A RIE hearing device has a receiver in the ITE housing. A MaRIE hearing device has both a receiver and at least a microphone in the ITE housing. Thus, FIG. 8b shows a BTE hearing device, where only a sound tube (no cable) is coming out of the BTE housing. FIGS. 8a, 8c and 8d may be either receiver in the ear (RIE) devices or microphone and receiver in the ear (MaRIE) device. Thus, the hearing device 2 may also comprise a tube 80 and an earpiece 82.

Although particular features have been shown and described, it will be understood that they are not intended to limit the claimed invention, and it will be made obvious to those skilled in the art that various changes and modifications may be made without departing from the scope of the claimed invention. The specification and drawings are, accordingly to be regarded in an illustrative rather than restrictive sense. The claimed invention is intended to cover all alternatives, modifications and equivalents.

### ITEMS

1. A hearing device configured to be worn in or at the ear of a user, the hearing device comprising:
a housing, comprising:
a first section comprising one or more first electronic components;
a second section comprising one or more second electronic components;
a third section connecting the first section and the second section;
a fourth section comprising a replaceable battery for supplying power;
wherein the first section and the second section are configured to move relative to each other between a first position and a second position of the first section relative to the second section;
wherein the fourth section is configured to be in an open position or in a closed position, and when the first section is in the first position relative to the second section, the fourth section is in the open position, wherein the fourth section is open to an outside environment of the housing, thereby the replaceable battery is accessible for replacement, and when the first section is in the second position relative to the second section, the fourth section is in the closed position, wherein the fourth section is sealed from the outside environment of the housing.

2. The hearing device according to any of the preceding items, wherein the one or more first electronic components are sealed, and wherein the one or more second electronic components are sealed.

3. The hearing device according to any of the preceding items, wherein the one or more first electronic components and the one or more second electronic components are sealed by coating and/or overmoulding.

4. The hearing device according to any of the preceding items, wherein the first, second, third and fourth sections are separate from each other.

5. The hearing device according to any of the preceding items, wherein the third section comprises an attachment component, wherein the first section and the second section are connected to each other via the third section at the attachment component, and wherein the first section and the second section are configured to be movable relative to each other around the attachment component.

6. The hearing device according to the preceding item, wherein the first section and the second section are configured to be movable relative to each other around the attachment component as a rotational movement or as a translational movement.

7. The hearing device according to any of the preceding items, wherein the first section comprises a first printed circuit board (PCB), and wherein the second section comprises a second printed circuit board (PCB), and wherein the third section comprises a third printed circuit board (PCB) electrically connecting the first section and the second section.

8. The hearing device according to the preceding item, wherein the third printed circuit board (PCB) is a flex PCB which is configured to be bendable, thereby allowing the fourth section to be in the open position, whereby the replaceable battery is accessible for replacement.

9. The hearing device according to items 7 or 8, wherein the attachment component comprises the third PCB.

10. The hearing device according to any of the preceding items, wherein the battery is configured for supplying power to the electronic components by means of one or more battery contacts, and wherein the one or more battery contacts are arranged in the first section and/or in the second section.

11. The hearing device according to any of the preceding items, wherein the housing is configured to be securily closed at the fourth section by means of a connector, snap-fit, magnetic elements, screw, pin, glue, adhesive, and/or a spring.

12. The hearing device according to any of the preceding items, wherein the first section is enclosed by a first physical shielding, and wherein the second section is enclosed by a second physical shielding.

13. The hearing device according to the preceding item, wherein the first physical shielding and/or the second physical shielding is/are a partition and/or an overmoulded material.

14. The hearing device according to any of the preceding items, wherein the hearing device is an in-the-ear (ITE) hearing device, a behind-the-ear (BTE) hearing device, a receiver-in-the ear (RIE) hearing device, a microphone-and-receiver-in-the-ear (MaRIE) hearing device and/or an earbud hearing device, and wherein the housing is an ITE shell, BTE shell and/or an earbud shell.

15. The hearing device according to any of the preceding items, wherein the one or more first electronic components is an input transducer.

16. The hearing device according to any of the preceding items, wherein the one or more second electronic components is an output transducer.

17. The hearing device according to any of the preceding items, wherein the replaceable battery is a rechargeable battery.

18. The hearing device according to any of the preceding items, wherein the hearing device comprises means for electrical connection, where the electrical connection is between the first section and the second section, and wherein the electrical connection is by means of an electrical connector and/or magnetic elements.

### LIST OF REFERENCES

2 hearing device
4 housing
6 first section
8 first electronic component(s)
10 second section
12 second electronic component(s)
14 third section
16 fourth section
18 replaceable battery
20 first position of the first section relative to the second section
22 second position of the first section relative to the second section
24 open position of fourth section
26 closed position of fourth section
28 first physical shielding
30 overmoulded material
32 second physical shielding
34 partition
36 attachment component
40 first printed circuit board (PCB)
42 second printed circuit board (PCB)
44 third printed circuit board (PCB)
50, 52 battery contacts
60, 62 connector
64 spring
66 adhesive
68 pin
70 magnetic elements
80 tube
82 earpiece
90 electrical connector

1. A hearing device configured to be worn in or at the ear of a user, the hearing device comprising:
a housing comprising:
a first section comprising one or more first electronic components;
a second section comprising one or more second electronic components;
a third section connecting the first section and the second section; and
a fourth section comprising a replaceable battery for supplying power;
wherein the first section and the second section of the housing are configured to move relative to each other between a first position and a second position of the first section relative to the second section;
wherein the fourth section is configured to be in an open position or in a closed position;
wherein when the first section is in the first position relative to the second section, the fourth section is in the open position, and the fourth section is open to an outside environment of the housing to allow replacement of the replaceable battery; and
wherein when the first section is in the second position relative to the second section, the fourth section is in the closed position, and the fourth section is sealed from the outside environment of the housing.

2. The hearing device of claim 1, wherein the one or more first electronic components are sealed, and wherein the one or more second electronic components are sealed.

3. The hearing device of claim 1, wherein the one or more first electronic components and the one or more second electronic components are sealed by coating and/or overmoulding.

4. The hearing device of claim 1, wherein the first, second, third and fourth sections are separate respective components.

5. The hearing device of claim 1, wherein the third section comprises an attachment component, wherein the first section and the second section are moveably coupled to each other via the attachment component of the third section.

6. The hearing device of claim 5, wherein the first section and the second section are translatable relative to each other via the attachment component.

7. The hearing device of claim 5, wherein the first section and the second section are rotatable relative to each other via the attachment component.

8. The hearing device of claim 5, wherein the attachment component comprises a printed circuit board (PCB).

9. The hearing device of claim 1, wherein the first section comprises a first printed circuit board (PCB), wherein the second section comprises a second printed circuit board (PCB), and wherein the third section comprises a third printed circuit board (PCB) electrically connecting the first section and the second section.

10. The hearing device of claim 9, wherein the third printed circuit board (PCB) is a flex PCB which is bendable to allow the fourth section to be in the open position.

11. The hearing device of claim 9, wherein the third PCB provides an attachment component that moveably couples the first section and the second section.

12. The hearing device of claim 1, wherein the replaceable battery is configured to supply power to the one or more first electronic components and the one or more second electronic components via one or more battery contacts, and wherein the one or more battery contacts are in the first section and/or in the second section of the housing.

13. The hearing device of claim 1, wherein the housing is configured to be securily closed at the fourth via a connector, a snap-fit element, magnetic elements, a screw, a pin, glue, adhesive, and/or a spring.

14. The hearing device of claim 1, wherein the first section is enclosed by a first physical shielding, and wherein the second section is enclosed by a second physical shielding.

15. The hearing device of claim 14, wherein each or one of the first physical shielding and the second physical shielding comprises a partition or an overmoulded material.

16. The hearing device of claim 1, wherein the hearing device is an in-the-ear (ITE) hearing device, a behind-the-ear (BTE) hearing device, a receiver-in-the ear (RIE) hearing device, a microphone-and-receiver-in-the-ear (MaRIE) hearing device and/or an earbud hearing device, and wherein the housing is an ITE shell, BTE shell and/or an earbud shell.

17. The hearing device of claim 1, further comprising an electrical connector and/or magnetic elements configured to electrically couple the first section and the second section.
